(19) United States
(12) Patent Application Publication
(10) Pub. No.: US 2009/0005081 A1
(43) Pub. Date: Jan. 1, 2009

(54) Communication system and information providing method

(75) Inventors: Meng-Cheng Chen, Taipei (TW); Wei-Hao Syu, Taipei (TW)

Correspondence Address: BACON & THOMAS, PLLC, 625 SLATERS LANE, FOURTH FLOOR, ALEXANDRIA, VA, 22314-1176, US

(73) Assignee: Arcadyan Technology Corporation, Hsinchu (TW)

(21) Appl. No.: 11/819,355

(22) Filed: Jun. 27, 2007

(51) Int. Cl. H04Q 7/20

(52) U.S. Cl. 455/456.5

(57) ABSTRACT

A communication system includes a mobile communication apparatus and a back-end server. The mobile communication apparatus is for respectively generating and outputting a piece of communication operation data, a piece of network operation data or a piece of multimedia playing operation data when a communication operation event, a network operation event or a multimedia playing operation event is triggered, wherein the mobile communication apparatus also detects and provides its position data. The back-end server is for receiving and analyzing the communication operation data or the network operation data to generate and output a piece of catalog statistic data. The mobile communication apparatus generates and outputs a piece of motion data to the back-end server in response to the multimedia playing operation data or the catalog statistic data. The back-end server provides active information to the mobile communication apparatus according to the position data and the motion data.

### BACKGROUND OF THE INVENTION

1. Field of the Invention

The invention relates in general to a communication system, and more particularly to a communication system automatically providing information in response to a user's mobile device.

2. Description of the Related Art

Along with technology development, wireless communication system has been widely applied in people's daily life. For example, a mobile-phone communication system including ten thousands of mobile phones and mobile-phone stations is, in fact, a wireless communication system having greatest influence.

In conventional technology, there exists a mobile-phone communication system integrated with a life information providing system, which provides the corresponding life information, such as eating, clothing, living, travel, education and entertainment, in response to user's request. However, how to design a communication system to provide more convenient, humanistic and automatic information service is one of the efforts the industries are making.

### SUMMARY OF THE INVENTION

The invention is directed to a communication system and method, which can resolve the drawback of the conventional communication system not being able to automatically provide information in response to a user's operation. The communication system and method have the advantage of being capable of providing information by analyzing the user's operation and responding the analysis result.

According to a first aspect of the present invention, a communication system is provided. The communication system comprises a mobile communication apparatus and a back-end server. The mobile communication apparatus is for respectively generating and outputting a piece of communication operation data, a piece of network operation data or a piece of multimedia playing operation data when a communication operation event, a network operation event or a multimedia playing operation event is triggered, wherein the mobile communication apparatus also detects and provides its position data. The back-end server is for receiving and analyzing the communication operation data or the network operation data to generate and output a piece of catalog statistic data. The mobile communication apparatus generates and outputs a piece of motion data to the back-end server in response to the multimedia playing operation data or the catalog statistic data. The back-end server provides active information to the mobile communication apparatus according to the position data and the motion data.

According to a second aspect of the present invention, an information providing method is provided. The information providing method comprises respectively generating and outputting a piece of communication operation data, a piece of network operation data or a piece of multimedia playing operation data when a communication operation event, a network operation event or a multimedia playing operation event is triggered; analyzing the communication operation data, the network operation data or the multimedia playing operation data to obtain a piece of motion data; detecting a position of a mobile communication apparatus to obtain a piece of position data; and finding out and outputting active information to the mobile communication apparatus according to the position data and the motion data.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a communication system according to a preferred embodiment of the invention is shown.

FIG. 2 is a detailed block diagram of the communication system of FIG. 1 is shown.

FIG. 3 is a flow chart of an information providing method according to the first embodiment of the invention.

FIG. 4 is another detailed block diagram of the communication system of FIG. 1.

FIG. 5 is another flow chart of an information providing method according to the second embodiment of the invention.

FIG. 6 is another detailed block diagram of the communication system of FIG. 1.

FIG. 7 is another flow chart of an information providing method according to the third embodiment of the invention.

### DETAILED DESCRIPTION OF THE INVENTION

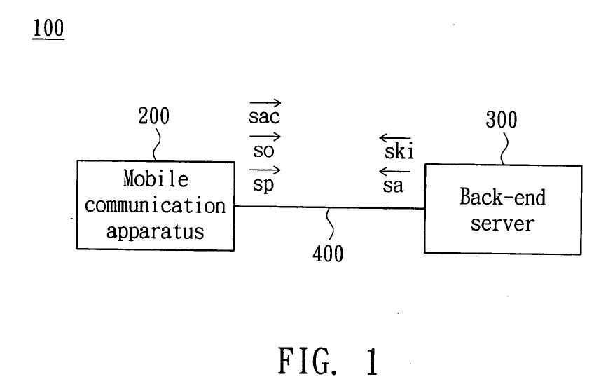

Referring to FIG. 1, a block diagram of a communication system according to a preferred embodiment of the invention is shown. A communication system 100 includes a mobile communication apparatus 200 and a back-end server 300, which are connected via a mobile-phone communication connection 400 for instance. The mobile communication apparatus 200 is for generating and outputting a piece of operation data so in response to a user operation event and generating a piece of position data corresponding to its own position.

The back-end server 300 is for receiving and analyzing the operation data (such as keyword) so to generate and output a piece of catalog statistic data to the mobile communication apparatus 200. The mobile communication apparatus 200 also receives the catalog statistic data and outputs a piece of operation data (such as communication operation data, network operation data, and multimedia playing operation data) to the back-end server 300. The back-end server 300 provides active information sa to the mobile communication apparatus 200 according to the position data sp and the motion data sm.

In the embodiment, the user triggers a communication operation event, network operation event or multimedia playing operation event via the communication apparatus 200, and the mobile communication apparatus 200 is used for respectively generating a piece of corresponding communication operation data soc, network operation data soi or multimedia playing operation data som when the above operation events are triggered, and outputting the operation data soc, soi or som as a piece of operation data so. The following description illustrates the detailed operations of the communication system when the user triggers the communication, network and multimedia playing operation events.

### Embodiment One

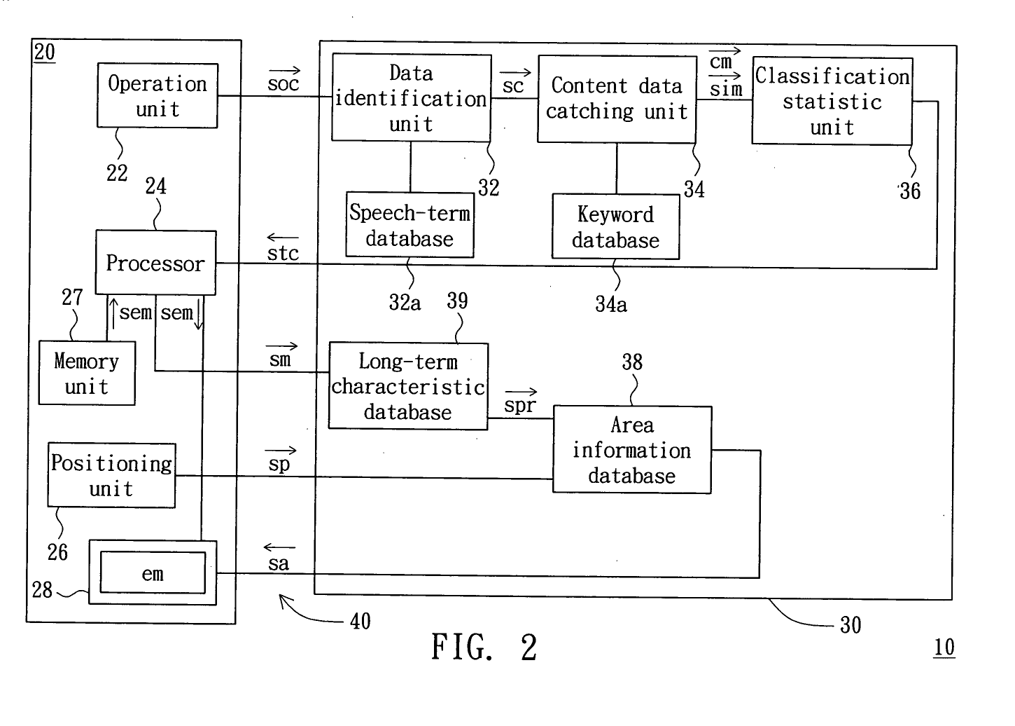

Referring to FIG. 2, a detailed block diagram of the communication system of FIG. 1 is shown. A communication system 10 includes a mobile communication apparatus 20 and back-end server 30. The mobile communication apparatus 20 includes an operation unit 22, a positioning unit 26 and a processor 24. The operation unit 22 is, for example, a user interface device, for generating and outputting the corresponding communication operation data soc to the back-end server 30 in response to the user's communication operation event.

The operation unit 22 of the embodiment includes a voice device, such as a microphone or speaker. When the user communicates with another user in voice via the mobile communication apparatus 20, the mobile communication apparatus 20 detects the communication operation event. At the time, the mobile communication apparatus 20 catches and outputs the voice data generated by the user as the communication operation data soc via the voice device.

The positioning unit 26 is for detecting a position of the mobile communication apparatus 20 in order to find the position data sp. The positioning unit 26 of the embodiment is, for example, a global positioning system (GPS) receiver for receiving a positioning signal sgps generated by a GPS positioning satellite and accordingly calculating the position data sp of the mobile communication apparatus 20.

The back-end server 30 includes a data identification unit 32, a content data catching unit 34, a classification statistic unit 36 and an area information database 38. The data identification unit 32 includes, for example, a speech-to-text engine for receiving the communication operation data soc and transforming the communication operation data soc by referring to a speech-term database 32a in order to obtain and output a piece of content data sc, which is a test data file for instance.

The content data catching unit 34 receives the content data sc, catches a number of pieces of keyword data sim (m=1˜i) and the corresponding catalog data cm from the content data sc by referring to a keyword database 34a and outputting the keyword data sim and catalog data cm. The keyword database 34a includes a number of keywords and the corresponding catalogs. For example, the keyword database 34a of the embodiment classifies the keywords into six motion catalogs of eating, clothing, living, travel, education and entertainment. Each motion catalog includes a number of keywords. For example, the motion catalog ‘eating’ includes keywords such as hungry, eat, food and restaurant.

The classification statistic unit 36 receives the keyword data sim and catalog data cm and does statistics of the number of keyword data sim with different catalog data cm to obtain statistic catalog data stc. The classification statistic unit 36 outputs the statistic catalog data stc to the mobile communication apparatus 20 via the mobile-phone communication connection 40.

The processor 24 receives the statistic catalog data stc and analyzes whether the user would like to execute any motion catalog according to the accumulated number of the keywords in each motion catalog of the statistic catalog data stc. When the number of keywords in one motion catalog of the statistic catalog data stc accumulated per unit of time has exceeded a threshold standard, the processor 24 determines the user has a higher intention to execute this motion catalog. At the time, the processor 24 generates the motion data sm and outputs the motion data sm through the mobile-phone communication connection 40. For example, the threshold value is 50. When the number of keywords of the motion catalog ‘eating’ of the statistic catalog data stc accumulated per unit of time exceeds 50, the processor 24 uses the motion catalog ‘eating’ as the motion data sm.

The motion data sm is outputted to the area information database 38 via the mobile-phone communication connection 40, and the area information database 38 is for recording information related to each motion catalog in a number of areas. The area information database 38 is for finding out the active information sa positioned near the user and related to the motion catalog to be executed according to the position data sp and motion data sm. For example, when the motion data sm is the motion catalog ‘eating’, the area information database 38 finds out the data related to ‘eating’ such as hotel, restaurant, snack at the surrounding area according to the position data sp and uses it as the active information sa.

The mobile communication apparatus 20 further includes a memory unit 27 and a display unit 28. The memory unit 27 stores electronic map data dem and the processor 24 is for reading the electronic map data dem and accordingly driving the display unit 28 to display an electronic map em. The display unit 28 further receives and displays the position data sp and the active information sa on the electronic map em.

Therefore, the communication system 10 of the embodiment can effectively generate the communication operation data soc in response to the communication operation event and perform a data analysis on the communication operation data soc to obtain the motion catalog that the user would like to execute. Then, the communication system 10 of the embodiment provides the related active information sa positioned near the user according to the obtained motion catalog and user's position.

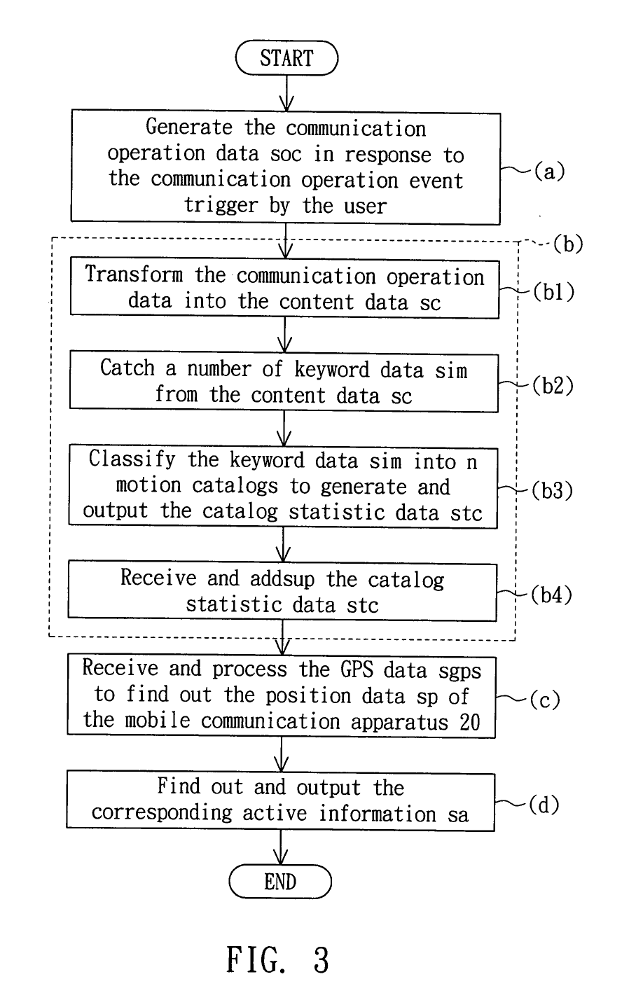

Referring to FIG. 3, a flow chart of an information providing method according to the first embodiment of the invention is shown. First, in step (a), the operation unit 22 generates the communication operation data soc in response to the communication operation event trigger by the user. Following that, in step (b), the back-end server 30 analyzes the communication operation data soc to obtain and output the catalog statistic data stc. The processor 24 finds out and outputs the motion data sm such as the motion catalog ‘eating’ in response to the accumulated number of keywords in each motion catalog of the catalog statistic data stc.

Next, in step (c), the positioning unit 26 receives and processes the GPS data sgps to find out the position data sp of the mobile communication apparatus 20. Then, in step (d), the area information database 38 finds out and outputs the corresponding active information sa to the mobile communication apparatus 20.

The step (b) includes steps (b1)˜(b4). In step (b1), the data identification unit 32 transforms the communication operation data into the content data sc. The data identification unit 32 includes, for example, a speech-to-text engine for transforming the communication operation data soc into the content data sc. Then, in step (b2), the back-end server 30 catches a number of keyword data sim, such as six motion catalogs, from the content data sc via the content data catching unit 34.

Afterward, in step (b3), the back-end server 30 classifies the keyword data sim into n motion catalogs via the classification statistic unit to generate and output the catalog statistic data stc to the mobile communication apparatus 20, wherein n is equal to 6 for instance. Next, in step (b4), the processor 24 receives and adds up the catalog statistic data stc. When the accumulated number of keywords in any motion catalog of the catalog statistic data stc exceeds a threshold value, the processor 24 generates and outputs the motion data sm.

Although the user performing speech communication in response to the communication operation event is taken an example for illustration in the embodiment, the communication system 10 of the embodiment can also generate communication operation data soc in response to other form of communication operation event and analyze the communication operation data soc to obtain the corresponding motion data sm.

For example, the operation unit 22 of the embodiment includes an information module. When the user performs an information communication with another user via the mobile communication apparatus 20, the mobile communication apparatus 20 detects the communication operation event. At the time, the mobile communication apparatus 20 outputs the information the user receives or sends out as the communication operation data soc via the information module. The back-end server 30 neglects the transformation operation of the data identification unit 32 on the communication operation data soc and directly finds out the catalog statistic data stc via the content data 34 and the catalog statistic unit 36.

Although the back-server 30 finding out the active information sa according to the area information database 38 is taken as an example for illustration in the embodiment, the back-end server of the embodiment can also achieve the purpose of providing the active information sa by referring to other database. For example, the back-end server 30 further includes a long-term characteristic database 39 having six motion catalogs, which the users are fond of, such as eating, clothing, living, travel, education and entertainment.

For example, when the motion data sm is the motion catalog ‘eating’, the long-term characteristic database 39 provides a further limitation requirement, such as Chinese food. At the time, the long-term characteristic database 39 provides hobby data spr, such as Chinese food, to the area information database 38 in order to find out the active information sa close to the user's hobby in the area information database 38. The long-term characteristic database 39 of the embodiment keeps a long-term record about the user-preset file construction data or inquiry data of the user through the mobile communication apparatus 20.

Although the motion to be performed by the user is exemplified to be the motion catalog ‘eating’ for illustration in the embodiment, when the obtained motion is any one of the motion catalogs clothing, living, travel, education and entertainment, the related operation can be reasoned by analog according to that of the motion catalog ‘eating’. Although the keyword database 34a is exemplified to classify the keyword data sim into the six motion catalogs eating, clothing, living, travel, education and entertainment to obtain the motion to be performed by the user for illustration in the embodiment, the keyword database 34a of the embodiment is not limited to performing motion classification by using the above method and can perform the classification by using any other method.

Although the operation unit 22 is exemplified to include the voice device such as a microphone and speaker for illustration in the embodiment, the operation unit 22 of the embodiment can also include a voice processing device for performing compression or coding on the voice data in order to reduce transmitted data amount and increase data accuracy. The data identification unit 32 of the embodiment further includes a calculation unit for performing de-compression or decoding on the received voice data before performing data identification on it.

The communication system of the embodiment generates the communication operation data soc and performs a data analysis on the communication operation data soc in response to the communication operation event triggered by the user in order to obtain the motion catalog the user would like to execute. Then, the communication system 10 of the embodiment provides the related active information sa close to the user according to the obtained motion catalog and the user's position. Therefore, the communication system of the embodiment can effectively prevent the drawback of the convention communication system not being able to automatically provide the information in response to the user's operation and can have the advantage of providing information by analyzing the user' operation and responding to the analysis result.

### Embodiment Two

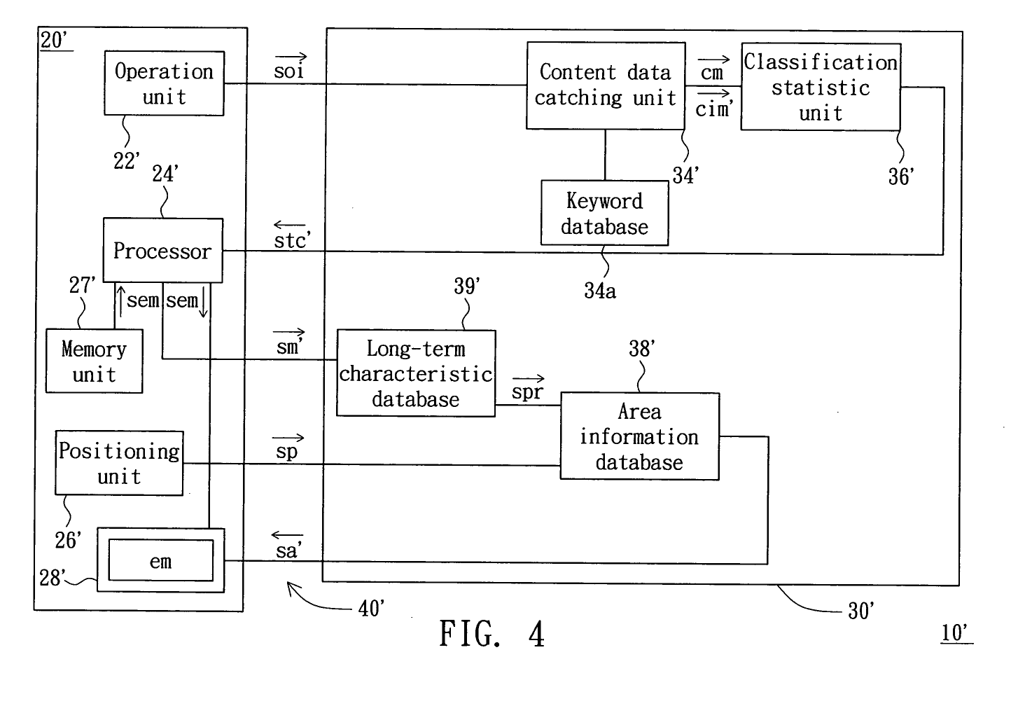

Referring to FIG. 4, another detailed block diagram of the communication system of FIG. 1 is shown. The communication system 10′ of the embodiment is different from the communication system 10 of the first embodiment by generating and outputting the corresponding network operation data soc to the back-end server in response to the user's network operation event and finding out the motion data sm′ and active information sa′ according to the network operation data soi.

The operation unit 22′ of the embodiment includes a network operation module for instance. When the user performs a network operation, such as browsing web pages or inquiring data by using a search engine, via the mobile communication apparatus 20′, the mobile communication apparatus 20′ detects the network operation event. At the time, the mobile communication apparatus 20 finds out the inquiry character, universal resource locator (URL) address and the surrounding text in web pages accessed by the network operation module and outputs them as the network operation data soi.

Following that, the content data catching unit 34′ and the classification statistic unit 36′ respectively catch keyword data sim′ and performs the classification statistics in order to generate catalog statistic data stc′. Then, the processor 34′, long-term characteristic database 39′, area information database 38′, positioning unit 26′ and display unit 28′ perform the similar operations as the corresponding units in the communication system 10 in order to display the active information sa′.

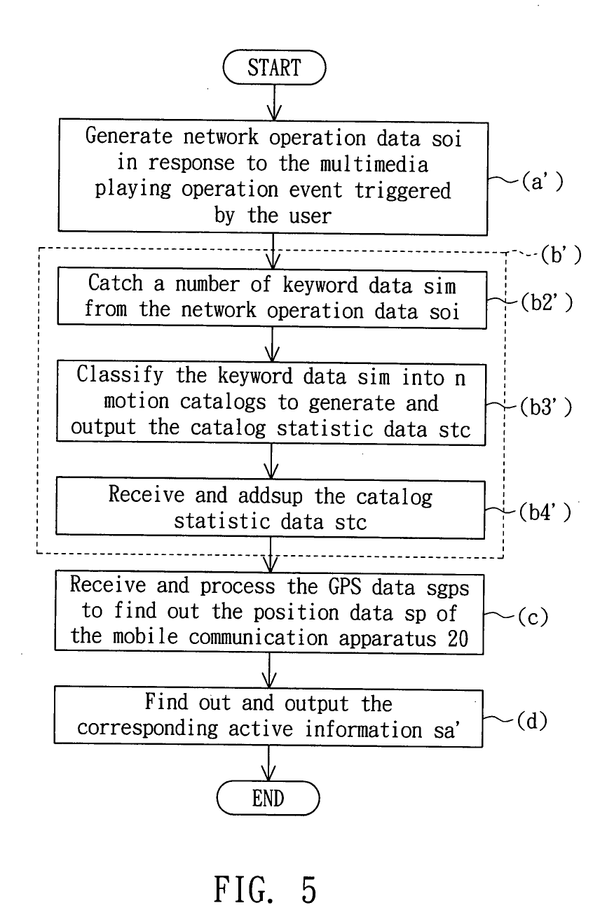

Referring to FIG. 5, another flow chart of the information providing method according to the second embodiment of the invention is shown. The information providing method of the embodiment is different from the information providing method of the first embodiment as below. In step (a′), the operation unit 22 generates network operation data soi in response to the network operation event triggered by the user. The step (b′) includes only steps (b2′), (b3′) and (b4′), which are similar to the corresponding steps (b2), (b3) and (b4) in the first embodiment, so as to perform a keyword data search, motion catalog classification and keyword number counting of each motion catalog on the network operation data soi and accordingly obtain active information sa′.

Therefore, the communication system 10′ of the embodiment can effectively generate the network operation data soi in response to the network operation event and perform a data analysis on the network operation data soi to obtain the motion catalog the user would like to execute. Then, the communication system 10′ of the embodiment provides the related active information sa′ close to the user according to the obtained motion catalog and the user's position. Therefore, the communication system of the embodiment can have the advantage of providing information by analyzing the user' operation and responding to the analysis result.

### Embodiment Three

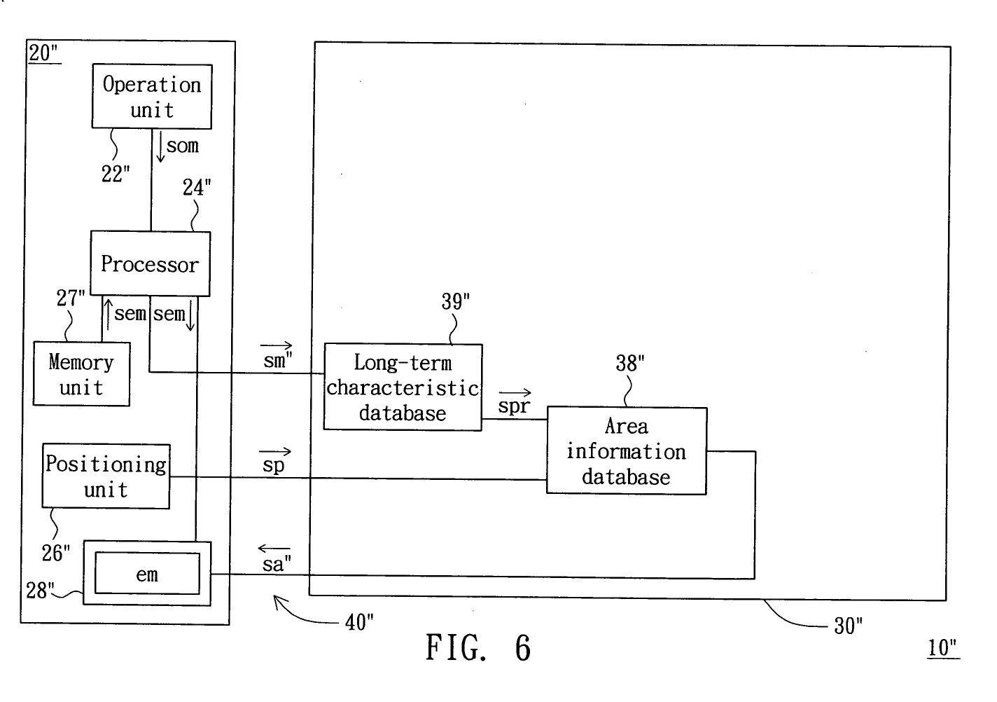

Referring to FIG. 6, another detailed block diagram of the communication system of FIG. 1 is shown. The communication system 10″ of the embodiment is different from the communication system 10 of the first embodiment by generating and outputting the corresponding multimedia playing operation data som in response to the user's multimedia playing operation event. The operation unit 22″ directly obtains and outputs motion data sm″ by arranging the multimedia playing operation data som and then the active information sa″ is found out via the back-end server 30″.

The operation unit 22″ of the embodiment includes a video/audio playing module for instance. When the user plays multimedia data, such as music data, network broadcast data strings or movie files, via the mobile communication apparatus 20″, the mobile communication apparatus 20″ detects the multimedia playing operation event. At the time, the mobile communication apparatus 20″ finds out metadata corresponding to the above multimedia data via the video/audio playing module and outputs it as the multimedia playing operation data som.

In the embodiment, when the multimedia data is music data with a MP3 (MPEG-1 Audio Layer 3) format, the metadata includes, for example, an ID3 tag for displaying information such as a music catalog, music editor, music name or collection name related to the multimedia data. When the multimedia data is network broadcast data string, the metadata includes, for example, a radio data system (RDS) tag for displaying the related name of the radio station, broadcast program information and other relevant information of the played multimedia information.

The video/audio playing module of the embodiment outputs the multimedia playing operation data som to the processor 24″ to add up the received metadata and accordingly determine whether the user would like to execute the related operation of playing multimedia data. For example, when the user continuously listen to the music related to the jazz catalog, the number of received metadata related to the jazz music exceeds a threshold value, the processor 24″ determines that the user would want to obtain the information related to the jazz music. At the time, the processor 24″ outputs the motion catalog ‘entertainment’ and jazz requirement as the motion data sm″ to the back-end server 30″.

Following that, long-term characteristic database 39′, area information database 38″, positioning unit 26″ and display unit 28″ perform the similar operations as the corresponding units in the communication system 10 in order to display the active information sa″.

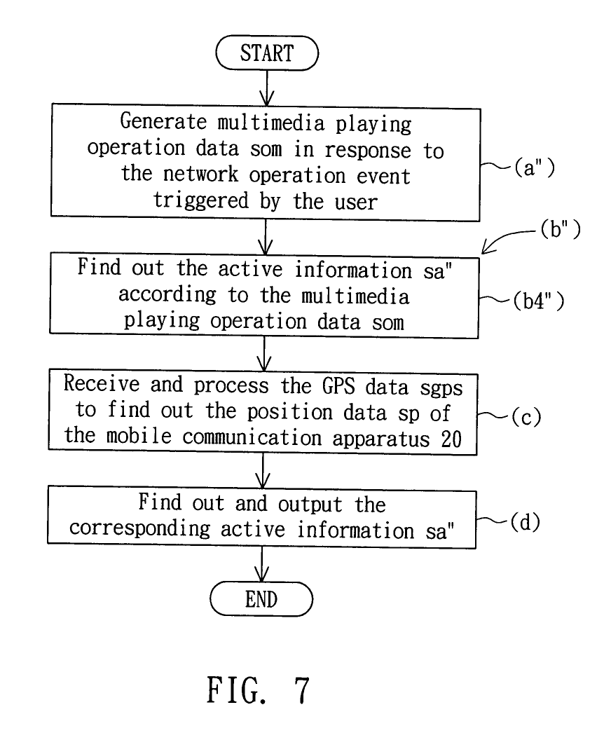

Referring to FIG. 7, another flow chart of the information providing method according to the third embodiment of the invention is shown. The information providing method of the embodiment is different from the information providing method of the first embodiment as below. In step (a″), the operation unit 22″ generates multimedia playing operation data som in response to the network operation event triggered by the user. The step (b″) includes only the step (b4′) in which the processor 24″ finds out the active information sa″ according to the multimedia playing operation data som.

Therefore, the communication system 10″ of the embodiment can effectively generate the multimedia playing operation data som in response to the multimedia playing operation event and obtain the motion catalog the user would like to execute according to the multimedia playing operation data som. Then, the communication system 10″ of the embodiment provides the related active information sa″ close to the user according to the obtained motion catalog and the user's position. Therefore, the communication system of the embodiment can have the advantage of providing information by analyzing the user' operation and responding to the analysis result.

Although the methods of the above three embodiments are exemplified for performing different user's operations, the communication system of the invention can also integrate software and hardware structure of the communication systems of the above three embodiments in any way to achieve the purpose of providing the corresponding active information in response to one of the above communication, network and multimedia playing operation events or their combination.

While the invention has been described by way of example and in terms of three embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication system, comprising:
a mobile communication apparatus, for respectively generating and outputting a piece of communication operation data, a piece of network operation data or a piece of multimedia playing operation data when a communication operation event, a network operation event or a multimedia playing operation event is triggered, wherein the mobile communication apparatus also detects and provides its position data; and
a back-end server, for receiving and analyzing the communication operation data or the network operation data to generate and output a piece of catalog statistic data;
wherein the mobile communication apparatus generates and outputs a piece of motion data to the back-end server in response to the multimedia playing operation data or the catalog statistic data;
wherein the back-end server provides active information to the mobile communication apparatus according to the position data and the motion data.

2. The communication system according to claim 1, wherein the back-end server comprises:
a data identification unit for receiving and transforming the communication operation data or the network operation data into a plurality of pieces of content data;
a content data catching unit, for receiving the content data and catching a plurality of pieces of keyword data from the content data;
a classification statistic unit, for classifying the keyword data into n motion catalogs in order to generate and output the catalog statistic data to the mobile communication apparatus, wherein n is a natural number larger than 1; and
an area information database, for recording information related to the n motion catalogs in a plurality of areas and finding out the active information according to the position data and the motion data.

3. The communication system according to claim 2, wherein the back-end server further comprises:
a long-term characteristic database for recording a characteristic profile, mapping the motion data into a piece of characteristic motion data in response to the characteristic profile, and outputting the characteristic motion data as the motion data.

4. The communication system according to claim 3, wherein the long-term characteristic database comprises one of a piece of preset characteristic data and a piece of long-term behavior record data, or both of them.

5. The communication system according to claim 1, wherein the mobile communication apparatus comprises:
an operation unit, for respectively generating the communication operation data, the network operation data or the multimedia playing operation data when the communication operation event, the network operation event or the multimedia playing operation event is triggered; and
a processor, for generating the motion data in response to the communication operation data or the catalog statistic data.

6. The communication system according to claim 1, wherein the mobile communication apparatus further comprises:
a positioning unit, for detecting a position of the mobile communication apparatus and accordingly generating the position data.

7. An information providing method, comprising:
(a) respectively generating and outputting a piece of communication operation data, a piece of network operation data or a piece of multimedia playing operation data when a communication operation event, a network operation event or a multimedia playing operation event is triggered;
(b) analyzing the communication operation data, the network operation data or the multimedia playing operation data to obtain a piece of motion data;
(c) detecting a position of a mobile communication apparatus to obtain a piece of position data; and
(d) finding out and outputting active information to the mobile communication apparatus according to the position data and the motion data.

8. The information providing method according to claim 7, wherein the step (b) comprises:
(b1) transforming the communication operation data or the network operation data into a piece of content data;
(b2) receiving the content data and catching a plurality of pieces of keyword data from the content data;
(b3) classifying the keyword data into n motion catalogs in order to generate and output a piece of catalog statistic data to the mobile communication apparatus, wherein n is a natural number larger than 1; and
(b4) finding out the motion data in response to the multimedia playing operation data or the catalog statistic data.

9. The information providing method according to claim 7, wherein the step (b) comprises:
(b1) receiving the content data and catching a plurality of pieces of keyword data from the content data;
(b2) classifying the keyword data into motion catalogs to generate and output the catalog statistic data; and
(b3) receiving the catalog statistic data.

10. The information providing method according to claim 7, wherein the step (b) comprises:
(b1) finding out the active information according to the multimedia playing operation data.
